(19) United States
(12) Patent Application Publication
(10) Pub. No.: US 2026/0118110 A1
(43) Pub. Date: Apr. 30, 2026

(54) SENSOR DEVICE AND ELECTRONIC DEVICE INCLUDING THE SAME

(71) Applicants: Samsung Display Co., Ltd., Yongin-Si (KR); Seoul National University R&DB Foundation, Seoul (KR)

(72) Inventors: Jae Ik LIM, Yongin-si (KR); Yongtaek HONG, Seoul (KR); Hayun KIM, Seoul (KR); Dongju JANG, Seoul (KR)

(21) Appl. No.: 19/362,157

(22) Filed: Oct. 17, 2025

(30) Foreign Application Priority Data
Oct. 28, 2024 (KR) 10-2024-0148364

(51) Int. Cl. G01B 7/16; G06F 3/03; G06F 3/038

(52) U.S. Cl. CPC G01B 7/22; G06F 3/03; G06F 3/038

(57) ABSTRACT

A sensor device includes a substrate having stretchability, a first wire and a second wire embedded in the substrate and spaced apart from each other in a first direction, and a deformation controller positioned on a first surface of the substrate. The first wire may overlap the second wire in the first direction to form a capacitor, and the deformation controller may overlap the capacitor in the first direction. A Young's modulus of the deformation controller may be greater than a Young's modulus of the substrate, and the substrate may have a gap between the first wire and the second wire.

### CROSS-REFERENCE TO RELATED APPLICATION

This application claims priority to and the benefit of Korean Patent Application No. 10-2024-0148364 filed on Oct. 28, 2024 in the Korean Intellectual Property Office, the entire contents of which are incorporated herein by reference.

### BACKGROUND

### 1. Field

The present disclosure relates to a sensor device and an electronic device including the same.

### 2. Description of the Related Art

The electronic device may have various functions. For example, the electronic device may be a wearable device and may include a display surface that displays an image on at least one side to display information. In addition, the electronic device may include a sensor for receiving a user's command.

The sensor of the electronic device may receive a command through various input means. For example, the pressure sensor may receive a command by sensing pressure of a user's hand or electronic pen. The pressure sensor may have various structures for sensing pressure. For example, as the structure of a pressure sensor changes depending on the applied force, its electrical characteristics may change leading to changes in its electrical signal, and information related to the applied forces may be received through the changed electrical signal.

### SUMMARY

Among electronic devices, wearable or stretchable electrode device may undergo shape changes, such as stretching (elongation) or bending, depending on the user's usage. At least a part of the pressure sensor included in the electronic device which is capable of deformation, such as stretching, may also experience deformation such as stretching, or the like, along with the electronic device.

Embodiments of the present disclosure are intended to increase the sensing accuracy and sensitivity of a pressure sensor included in a deformable electronic device, such as stretching.

According to an embodiment, a sensor device includes a substrate having stretchability, a first wire and a second wire embedded in the substrate and spaced apart from each other in a first direction, and a deformation controller positioned on a first surface of the substrate. The first wire may overlap the second wire in the first direction to form a capacitor, and the deformation controller may overlap the capacitor in the first direction. A Young's modulus of the deformation controller may be greater than a Young's modulus of the substrate, and the substrate may have a gap between the first wire and the second wire.

The gap may be filled with air.

The substrate may include a first portion embedding the first wire and a second portion embedding the second wire. The first portion may have a first gap surface defining the gap, and the second portion may have a second gap surface defining the gap and facing the first gap surface.

Each of the first gap surface and the second gap surface may include a curved surface.

Each of the first gap surface and the second gap surface may be parallel to each other.

Each of the first wire and the second wire may include a corrugated structure.

Each of the first wire and the second wire may include poly(3,4-ethylenedioxy-thiophene)-poly(styrene sulfonate) (PEDOT:PSS), and a silver nanowire (AgNW).

The deformation controller may overlap one end of the first wire or be aligned with the one end in the first direction.

The deformation controller may include plastic.

The sensor device may further include a deformation sensor positioned on a first surface of the substrate or a second surface of the substrate facing the first surface.

The deformation sensor may be spaced apart from the capacitor in the first direction.

The deformation sensor may be spaced apart from the deformation controller in a plane.

The sensor device may further include a signal processor using a sensing signal of the deformation sensor, separating the influence of deformation in the planar direction of the substrate from a sensing signal of the pressure sensor, and generating a sensing data corresponding to a pressure in the first direction.

According to an embodiment, a sensor device includes a substrate having stretchability, a first wire and a second wire embedded in the substrate and spaced apart from each other in the first direction, a deformation controller positioned on a first surface of the substrate, and a deformation sensor positioned on the first surface of the substrate or a second surface of the substrate facing the first surface. The first wire may overlap the second wire in the first direction to form a capacitor, and the deformation controller may overlap the capacitor in the first direction. The deformation sensor may be spaced apart from the capacitor in the first direction.

The deformation sensor may be spaced apart from the deformation controller in a plane.

The sensor device may further include a signal processor using a sensing signal of the deformation sensor, separating the influence of deformation in the planar direction of the substrate from a sensing signal of the pressure sensor, and generating a sensing data corresponding to the pressure in the first direction.

Each of the first wire and the second wire may include a corrugated structure.

The deformation controller may overlap one end of the first wire or be aligned with the one end in the first direction.

According to an embodiment, an electronic device includes a display panel and a sensor device overlapping the display panel. The sensor device may include a substrate having stretchability, a first wire and a second wire embedded in the substrate and spaced apart from each other in a first direction, and a deformation controller positioned on the first surface of the substrate. The first wire may overlap the second wire in the first direction to form a capacitor, and the deformation controller may overlap the capacitor in the first direction. A Young's modulus of the deformation controller may be greater than a Young's modulus of the substrate, and each of the first wire and the second wire may include a corrugated structure.

The electronic device may further include a deformation sensor positioned on a first surface of the substrate or a second surface of the substrate facing the first surface may be further included.

According to embodiments, it is possible to increase the sensing accuracy and sensitivity of a pressure sensor included in an electronic device that may be deformed such as a stretch or a contraction.

### BRIEF DESCRIPTION OF THE DRAWINGS

FIG. 1 is a plan view of an electronic device including a sensor device according to an embodiment.

FIG. 2 is a cross-sectional view of an electronic device including a sensor device according to an embodiment.

FIG. 3 is a cross-sectional view of a sensor device according to an embodiment.

FIGS. 4, 5, and 6 respectively illustrate a planar structure of a wire included in a sensor device according to an embodiment.

FIG. 7 illustrates a cross-sectional structure of a wire of a sensor device according to an embodiment.

FIG. 8 illustrates a strain rate on the surface of a substrate around a deformation controller included in a sensor device according to an embodiment.

FIG. 9 illustrates a strain rate in a cross-section of a substrate around a deformation controller included in a sensor device according to an embodiment.

FIG. 10 illustrates a graph (a, b, c) showing changes in capacitance according to a pressure applied to a sensor before stretch and after stretch of an electronic device including a sensor device according to an embodiment, and a table showing capacitance data of the sensor.

FIG. 11 is a graph showing changes in capacitance according to a pressure applied to a pressure sensor before stretch (a and b) and after stretch (c and d) of an electronic device including a sensor device according to an embodiment.

FIG. 12 is a cross-sectional view of a sensor device according to an embodiment.

FIG. 13 is a cross-sectional view of a sensor device according to an embodiment.

FIG. 14 is a drawing sequentially illustrating sequential processes of a method of manufacturing a sensor device according to an embodiment.

FIG. 15 is a cross-sectional view illustrating a process step in a method of manufacturing a sensor device according to an embodiment.

FIG. 16 is a cross-sectional view illustrating a process step in a method of manufacturing a sensor device according to an embodiment.

FIG. 17 is a cross-sectional view illustrating a process step after the process step shown in FIG. 16 in a method of manufacturing a sensor device according to an embodiment.

FIG. 18 is a cross-sectional view illustrating a process step in a method of manufacturing a sensor device according to an embodiment.

FIG. 19 is a cross-sectional view illustrating a process step after the process step shown in FIG. 18 in a method of manufacturing a sensor device according to an embodiment.

FIG. 20 is a block diagram of an electronic device according to an embodiment.

FIG. 21 to FIG. 23 are schematic diagrams of electronic devices according to various embodiments.

### DETAILED DESCRIPTION

Hereinafter, various embodiments of the present disclosure will be described in detail with reference to the accompanying drawings so that those of ordinary skilled in the technical field to which the present disclosure pertains can easily implement it. The present disclosure may be implemented in various different forms and is not limited to the embodiments described herein.

In order to clearly describe the present disclosure, parts irrelevant to the description are omitted, and the same reference numerals are applied to the same or similar components throughout the specification.

In addition, the size and thickness of each component shown in the drawing are arbitrarily shown for convenience of explanation, so the present disclosure is not necessarily limited to those shown. In order to clearly express several layers and regions in the drawing, the thickness is enlarged. And in the drawing, for convenience of explanation, the thicknesses of some layers and regions are exaggerated.

In addition, when an element such as a layer, film, region, or substrate is referred to as being “above” or “on” another element, this may include not only the case where the element is “directly on” another element but also the case where the element is “indirectly on” another element, for example, there is other element in the middle between the element and another element. In contrast, when an element is referred to as being “directly on” another element, there are no intervening elements present between the element and another element. In addition, being “above” or “on” a reference part means being positioned above or below the reference part and does not necessarily mean being positioned “above” or “on”it in the opposite direction of gravity.

In addition, throughout the specification, unless stated to the contrary, the word, “include,” “comprise,” or “have” and its variations such as “including,” “comprising,” “having,” or etc. should be understood to imply the inclusion of the stated elements but not exclusion of any other elements.

In addition, throughout the specification, the term “on a plane” refers to viewing the target part from above, and the term “cross-section” refers to viewing a vertical cut of the target part from the side.

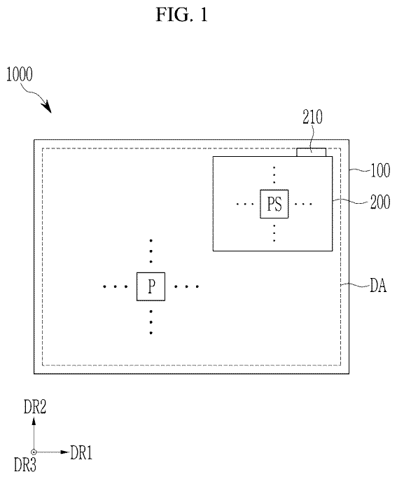

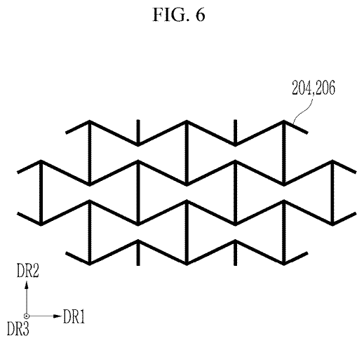

A sensor device and an electronic device including the same according to an embodiment will be described with reference to FIGS. 1 to 11.

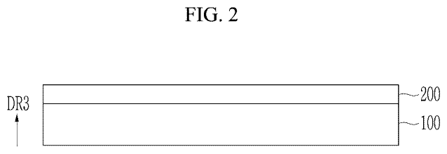

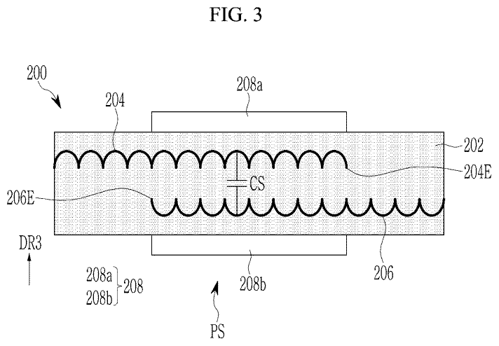

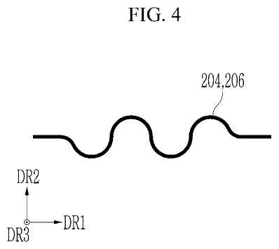

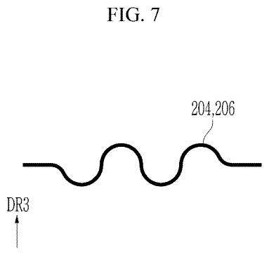

FIG. 1 is a plan view of an electronic device including a sensor device according to an embodiment. FIG. 2 is a cross-sectional view of an electronic device including a sensor device according to an embodiment. FIG. 3 is a cross-sectional view of a sensor device according to an embodiment. FIGS. 4, 5, and 6 respectively illustrate a planar structure of a wire included in a sensor device according to an embodiment. FIG. 7 illustrates a cross-sectional structure of a wire of a sensor device according to an embodiment.

Referring to FIGS. 1 and 2, the electronic device 1000 according to an embodiment may be various electronic devices such as a smartphone, a television, a tablet PC, a mobile phone, a video phone, an e-book reader, a desktop PC, a laptop PC, a netbook computer, a workstation, a server, a PDA, a portable multimedia player (PMP), an MP3 player, a medical device, a camera, or a wearable device. An electronic device is at least partially flexible and capable of being deformed. For example, the electronic device may be a flexible electronic device, a rollable electronic device, a bendable electronic device, a stretchable electronic device, or a curved electronic device.

The electronic device 1000 according to an embodiment may be implemented as a display device including a display surface displaying an image on at least one surface. Referring to FIGS. 1 and 2, the electronic device 1000 implemented as the display device according to an embodiment may include a display panel 100 and a sensor device 200 (also referred to as a sensor unit or a sensor array).

The display panel 100 may include a substrate and a plurality of pixels P formed on the substrate. Each pixel P is a unit capable of displaying an image and may include a pixel circuit unit including at least one transistor and a light emitting element. Each pixel P may have a light emitting region, which is a region where the light emitting element displays an image. The light emitting element may include, but is not limited to, an organic light emitting layer or an inorganic light emitting layer. A plurality of pixels P may display an image observable in a third direction DR3 perpendicular to a plane parallel to a first direction DR1 and a second direction DR2.

The display panel 100 may include a display area DA, which is an area in which a plurality of pixels P are arranged, and an image may be displayed, and a peripheral area which is an area around the display area DA. Voltage lines and signal lines for driving the pixels P may be located on the display panel 100.

The display panel 100 may have flexibility to extend or contract in a direction parallel to the first and/or second directions DR1 and DR2.

The sensor device 200 may include at least one pressure sensor PS (or a tactile sensor capable of sensing pressure) capable of sensing an external pressure. The pressure sensor PS may be a capacitive pressure sensor whose capacitance may change in response to an external pressure.

The sensor device 200 may overlap the display panel 100 in the third direction DR3. The sensor device 200 may overlap the display area DA of the display panel 100.

When the sensor device 200 is positioned toward the direction in which the display panel 100 displays an image as shown in FIG. 2 and overlaps the display panel 100, at least a portion of the sensor device 200 may have a light-transmitting property that allows light to pass through. However, the present disclosure is not limited thereto, and the sensor device 200 may be optically opaque or may have various degrees of light transmission.

Unlike as shown in FIG. 2, the sensor device 200 is located on the side through which the display panel 100 does not display an image, for example, below the display panel 100, and may overlap with the display panel 100.

According to an embodiment, the display panel 100 may display an image in both the third direction DR3 and the opposite direction to the third direction DR3, for example, upward and downward directions.

Referring to FIG. 1, the sensor device 200 may further include a signal processor 210 for processing a sensing signal from the pressure sensor PS.

Referring to FIG. 3, a sensor device 200 according to an embodiment may include a substrate 202 and a plurality of wires 204 and 206 (or referred to as electrodes) embedded in the substrate 202.

The substrate 202 may have flexibility to be stretched or contracted in a direction different from the third direction DR3, for example, in a direction parallel to the first direction DR1 and/or the second direction DR2 as shown in FIG. 1 (hereinafter, this direction will be referred to as a planar direction, and a direction perpendicular to this will be referred to as a thickness direction). The substrate 202 may have stretchability that allows it to be stretched in a planar direction and then restored to its original shape/position when the stretching force disappears. The substrate 202 may also have flexibility or stretchability in a thickness direction which is the third direction DR3.

The substrate 202 may include a material having stretchability. For example, the substrate 202 may include a flexible polymer material. The substrate 202 may include one or more of various elastic materials such as silicone-based flexible materials such as PDMS (polydimethylsiloxane), urethane-based elastic materials, or acrylic-based elastic materials.

The substrate 202 may have optical transparency that transmits at least a portion of incident light.

The wires 204 and 206 embedded in the substrate 202 may include a first wire 204 and a second wire 206 that are spaced apart from each other in the third direction DR3. A distance between the first wire 204 and the second wire 206 in the third direction DR3 may be 0.1 mm to 5 mm, but is not limited thereto.

The first distance between the first wire 204 and the closest surface of the substrate 202 in the cross-sectional view illustrated in FIG. 3, for example, the upper surface of the substrate 202 (hereinafter, the first distance will be referred to as the embedding depth from the upper surface of the substrate 202) may be greater than 0, and the second distance between the second wire 206 and the closest surface of the substrate 202 in the cross-sectional view illustrated in FIG. 3, for example is, the lower surface of the substrate 202 (hereinafter, the second distance will be referred to as the embedding depth from the lower surface of the substrate 202) may also be greater than 0.

The first wire 204 and the second wire 206 include portions overlapping each other in the third direction DR3, and the first wire 204 and the second wire 206 overlapping each other may form a capacitor CS with a portion of the substrate 202 as a dielectric between the first wire 204 and the second wire 206. A portion of the first wire 204 and the second wire 206 that overlap each other and form a capacitor CS may form a pressure sensor PS. The pressure sensor PS may transmit a change in capacitance of the capacitor CS caused by a change of spacing between the first wire 204 and the second wire 206 as a sensing signal to the signal processor 210 shown in FIG. 1, and the signal processor 210 may generate sensing data regarding the presence or absence of pressure on the pressure sensor PS and the magnitude of the applied pressure.

A plurality of pressure sensors PS formed on the substrate 202 may be provided, and an array may be formed in an array, such as a matrix pattern, on a plane.

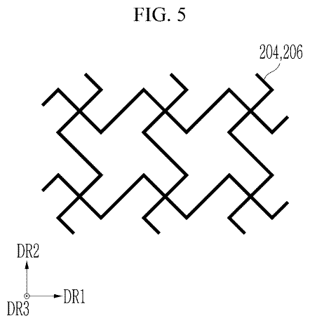

Each of the wires 204 and 206 may have a shape in which at least a portion is curved. Referring to FIGS. 3 and 4, each of the wires 204 and 206 may have a crooked/curved shape or a corrugated structure in a plan view. Referring to FIGS. 3, 5, and 6, each of the wires 204 and 206 has a bent shape with regularity in various forms in a plan view. Referring to FIGS. 3 and 7, as shown in FIGS. 4, 5, or 6, the wires 204 and 206 may have a crooked/curved shape, a corrugated structure, or an uneven structure in a cross-sectional view along with the bent shape of the wires 204, 206. The crooked or curved shape of the wires 204, 206 in the third direction DR3 may be formed using various methods, such as by making the surface of the substrate 202 uneven and then screen printing conductive ink for the wires 204, 206 on it, or by printing conductive ink for the wires 204, 206 on a stretched substrate 202 and then returning the stretched substrate 202 into the original state (contracting or shrinking). The curved or crooked wires 204, 206 on a plane may be formed when printing conductive ink for wires 204, 206.

The wires 204 and 206 according to an embodiment may have flexibility or stretchability, and may have optical transparency to transmit at least a portion of incident light. The wires 204 and 206 may include at least one of a flexible conductive metal material and a conductive polymer. The wires 204 and 206 may include one or more of a nanostructure such as conductive nanowires, conductive nanotubes, conductive nanorods, conductive nanofibers, conductive polymers such as poly(3,4-ethylenedioxy-thiophene)-poly(styrene sulfonate) (PEDOT:PSS), or a combination thereof. The conductive nanowire may be a silver nanowire AgNW. For example, the wires 204 and 206 may include AgNW-PEDOT:PSS in which silver nanowires and PEDOT:PSS are mixed. The wires 204 and 206 may be manufactured by printing ink of such a conductive material.

Due to the material properties of the wires 204 and 206, and the morphological properties, such as the crooked/curved shape or the corrugated structure of the wires 204 and 206, the rate of resistance change in the wires 204 and 206 may be reduced even when the substrate experiences deformation through stretch or contraction in the planar direction.

The sensor device 200 according to an embodiment may further include a deformation controller 208 (or also referred to as a stress controller). The deformation controller 208 may be positioned on the upper and/or the lower surface of the substrate 202 and may be positioned corresponding to the pressure sensor PS. That is, the deformation controller 208 may overlap each pressure sensor PS in the third direction DR3, and may be included in the pressure sensor PS. The deformation controller 208 may be in direct contact with the upper surface and/or the lower surface of the substrate 202, and components of a treatment solution (e.g., APTES, etc.) for adhesion may remain at the interface.

The deformation controller 208 may be attached to an upper surface and/or a lower surface of the substrate 202. The interface at which the deformation controller 208 and the substrate 202 are bonded may be surface-treated to improve bonding strength between the deformation controller 208 and the substrate 202. The surface treatment method of the deformation controller 208 may use plasma or perform surface treatment with a solution such as 3-Aminopropyltriethoxysilane (APTES) that may directly form chemical bonds with the material contained in the deformation controller 208.

The deformation controller 208 may include a first deformation controller 208a positioned on the upper surface of the substrate 202 on the first wire 204, and a second deformation controller 208b positioned on the lower surface of the substrate 202 under the second wire 206. However, the present disclosure is not limited thereto. For example, one of the first deformation controller 208a and the second deformation controller 208b may be omitted.

The first deformation controller 208a may have an edge overlapping one end 204E of the first wire 204 or aligned with one end 204E in the third direction DR3. The second deformation controller 208b may have an edge overlapping one end 206E of the second wire 206 or aligned with one end 206E in the third direction DR3. The deformation controller 208 may completely overlap the capacitor CS portion of the corresponding pressure sensor PS in the third direction DR3.

The deformation controller 208 may have a Young's modulus (also referred to as an elastic modulus) greater than that of the substrate 202. That is, the deformation controller 208 may have lower stretchability and flexibility than the substrate 202. Therefore, when pressure is applied to the pressure sensor PS in the third direction DR3, the structure of the pressure sensor PS (e.g., the spacing between the first wire 204 and the second wire 206) changes, but when the sensor device 200 is stretched in the planar direction (left and right directions), the change in the structure of the pressure sensor PS may be minimized. When the sensor device 200 is stretched in the planar direction, the changes in the shapes of the substrate 202 and the wires 204 and 206 of the pressure sensor PS may be minimized to prevent changes in the resistance of the wires 204 and 206 and the capacitance of the capacitor CS. Therefore, the pressure sensor PS may accurately sense the pressure in the third direction DR3 by inducing a change in the capacitor CS only in response to the pressure in the third direction DR3, and may prevent an incorrect pressure sensing caused by the changes in the capacitor CS due to the stretch in the planar direction of the sensor device 200. That is, according to an embodiment, the accuracy and sensitivity of the pressure sensor PS may be increased.

The Young's modulus of the deformation controller 208 may be, for example, 1.6 GPa or more. The Young's modulus of the deformation controller 208 may be 2.3 GPa or more, but is not limited thereto. The deformation controller 208 may include one or more materials with high Young's modulus, for example, epoxy resin, elastomer, or plastic. The plastic may include polyethylene naphthalate PEN, silicon resin, polyurethane PU, polyimide PI, polyethylene terephthalate PET, or the like.

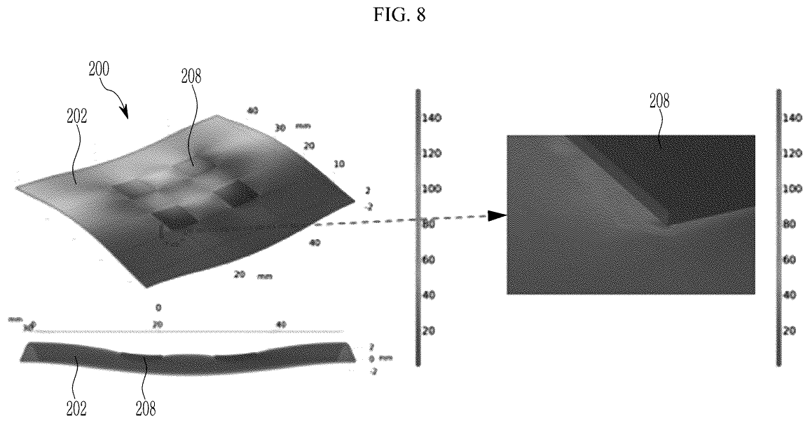

A sensor device 200 according to an embodiment will be described with reference to FIGS. 8 to 10 together with the previous drawings.

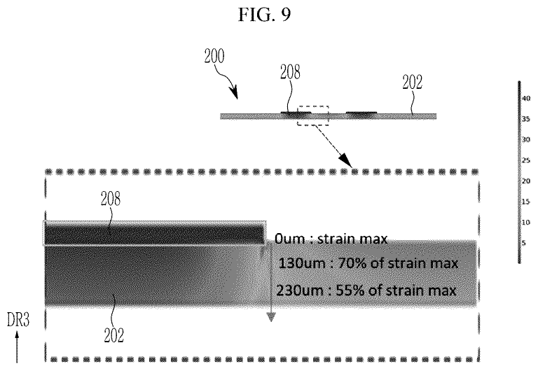

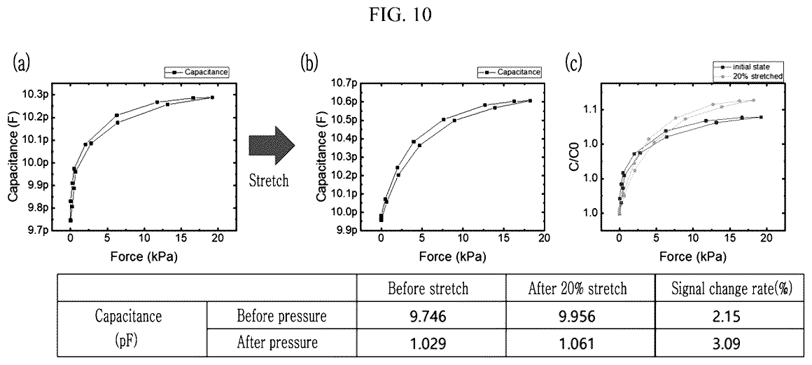

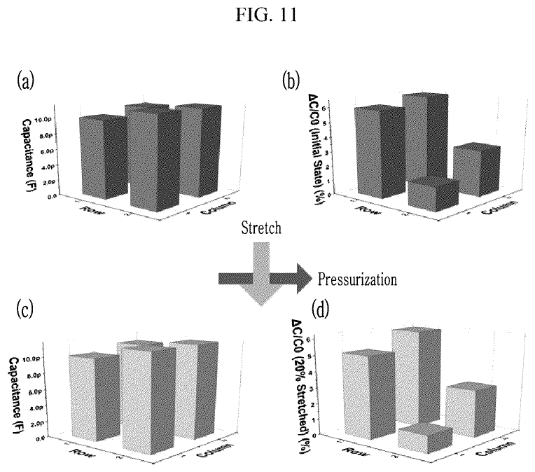

FIG. 8 illustrates a strain rate on the surface of a substrate around a deformation controller included in a sensor device according to an embodiment. FIG. 9 illustrates a strain rate in a cross-section of a substrate around a deformation controller included in a sensor device according to an embodiment. FIG. 10 is a graph (a, b, c) showing changes in capacitance according to a pressure applied to a sensor before stretch and after stretch of an electronic device including a sensor device according to an embodiment, and a table showing capacitance data of the sensor. FIG. 11 is a graph showing changes in capacitance according to a pressure applied to a pressure sensor before stretch (a and b) and after stretch (c and d) of an electronic device including a sensor device according to an embodiment.

Referring to FIGS. 8 and 9 along with the previous drawings, when the substrate 202 of the sensor device 200 is deformed (stretched or contracted) in the planar direction, the portion overlapping the deformation controller 208 receives minimal stress, but the peripheral area of the deformation controller 208 receives strong stress. The surface of the substrate 202 may be applied with the greatest stress. FIG. 9 shows that the greatest stress occurs on the surface of the stretched substrate 202 and the magnitude of the stress decreases toward the inside of the substrate 202. For example, the stress received at a depth of 130 micrometers from the surface of the substrate 202 is approximately 70% of the maximum strain applied to the surface of the substrate 202, and the stress received at a depth of 230 micrometers from the surface of the substrate 202 is approximately 55% of the maximum strain applied to the surface of the substrate 202.

According to an embodiment, the portion where the wires 204 and 206 overlap each other to form the capacitor CS may minimize the influence of the stretch in the planar direction due to the deformation controller 208, and the portions of the wires 204 and 206 that do not overlap with the deformation controller 208 are also embedded in the substrate 202, thereby reducing the stress applied to the portions of the wires 204 and 206 that do not overlap with the deformation controller 208 during the stretch of the substrate 202. That is, since the wires 204 and 206 are embedded in the substrate 202, compared to a structure in which the wires 204, 206 are located on the surface of the substrate 202, the stress applied to the wires 204 and 206 may decrease when the substrate 202 experiences the stretch and the contraction in the planar direction, and the change in resistance of the wires 204, 206 may be effectively reduced.

As described above, according to an embodiment, even when a stretch is applied to the sensor device 200 in a direction other than the third direction DR3, a structural change of the pressure sensor PS such as a resistance change of the wires 204 and 206 and a spacing change between the two wires 204 and 206 may be minimized. Therefore, the sensitivity and accuracy of the pressure sensor PS may be further increased.

Reflecting the data of FIG. 9, the embedding depth of the wires 204, 206 according to an embodiment may be 130 micrometers or more from the surface of the closest (or neighboring) substrate 202. However, the present disclosure is not limited thereto, and the embedding depth of the wires 204, 206 may vary depending on conditions such as the material and thickness of the substrate 202.

The wires 204, 206, as described above, has a crooked/curved shape or a corrugated structure not only on the plane but also in the cross-section. As a result, the resistance change of the wires 204, 206 may be reduced when the substrate 202 is deformed, for example, being stretched or contracted, in the planar direction. For example, when the wires 204 and 206 includes silver nanowires AgNW, the resistance change of the wires 204 and 206 is less than 5% at 20% stretch rate of the substrate 202 in the planar direction.

The pressure sensor PS including the wires 204 and 206 in a crooked/curved shape or a corrugated structure may exhibit high sensitivity even at a low pressure in the third direction DR3 (e.g., 0.67 kPa).

FIG. 10(a) shows changes in the capacitance of a capacitor CS depending on the pressure applied in the third direction DR3 with respect to a pressure sensor PS. FIG. 10(b) shows changes in the capacitance of a capacitor CS depending on the pressure applied in the third direction DR3 with respect to a pressure sensor PS after stretch (for example, at 20% stretch rate) in the planar direction of a substrate 202. FIG. 10(c) shows changes in the capacitance CS in both the initial state shown in FIG. 10(a) and the state after 20% stretch of the substrate 202 shown in FIG. 10(b), and the table shows the capacitance data of the capacitor CS of the pressure sensor PS when the pressure of, for example, 0.67 kPa is applied in the third direction DR3d.

FIG. 10 shows that the pressure sensor PS according to an embodiment operates sensitively to the pressure in the third direction DR3 regardless of whether the substrate 202 is stretched in the planar direction. As the capacitance changes of the pressure sensor PS before and after the stretch in the planar direction of the substrate 202 is less than 4%, it may be confirmed that the pressure sensor PS may accurately and sensitively sense the pressure in the third direction DR3 without being significantly affected by the stretch in the planar direction of the substrate 202.

FIG. 11(a) shows the capacitances of four pressure sensors PS before the stretch in the planar direction of the substrate 202, and FIG. 11(b) shows the capacitances of four pressure sensors PS when a pressure in a third direction DR3 is applied to two pressure sensors among the four pressure sensors PS in FIG. 11(a). FIG. 11(c) shows the capacitances of four pressure sensors PS after the stretch in the planar direction of the substrate 202, and FIG. 11(d) shows the capacitances of four pressure sensors PS when a pressure in a third direction DR3 is applied to two pressure sensors PS among the four pressure sensors PS in FIG. 11(c).

Similar to FIG. 10, the data in FIG. 11 also shows that the pressure sensor PS according to an embodiment may sensitively and accurately sense the pressure in the third direction DR3 without a significant change in the capacitance of capacitor CS before and after the stretch in the planar direction of the substrate 202. That is, the pressure sensor PS according to an embodiment does not change significantly in its electrical characteristics even when the substrate 202 is subject to the deformation such as the stretch in the planar direction of the substrate 202 rather than the thickness direction. As a result, the pressure in the third direction DR3 may be accurately and sensitively detected regardless of whether the sensor device 200 including the substrate 202 is deformed or not.

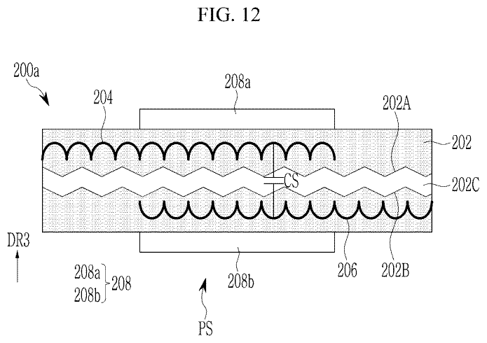

FIG. 12 is a cross-sectional view of a sensor device according to an embodiment.

Referring to FIG. 12, the sensor device 200a according to an embodiment is similar to the sensor device 200 explained above, but the substrate 202 may have a space 202C (or gap) between the first wires 204 and the second wires 206. The gap 202C may be filled with air and a space where no material is present.

The substrate 202 embedding the first wire 204 may have a first gap surface 202A located on an opposite side to the upper surface of the substrate 202, and the substrate 202 embedding the second wire 206 may have a second gap surface 202B located on an opposite side to the lower surface of the substrate. The first gap surface 202A and the second gap surface 202B may define a gap 202C and may face each other with the gap 202C therebetween.

In the cross-sectional view, the first gap surface 202A and the second gap surface 202B may have curved surfaces. The curved surface extends in a direction different from the planar direction and the third direction DR3 and may have an inclined surface that slopes in at least two directions. However, the shapes of the first gap surface 202A and the second gap surface 202B are not limited to the illustrated shape, and the first gap surface 202A and the second gap surface 202B may have different curved surfaces than those explained above. For example, the curved surface may have sharp high and low points, as shown in FIG. 12, or may have rounded high and low points. The curved surfaces of the first gap surface 202A and the second gap surface 202B in the cross-sectional view may have an embossed shape or an uneven structure.

The first gap surface 202A and the second gap surface 202B, which face each other, may be substantially parallel to each other, and may generally maintain a constant spacing.

According to an embodiment, the dielectric of the capacitor CS of the pressure sensor PS may include a gap 202C in addition to the material of the substrate 202.

According to an embodiment, the deformation of the pressure sensor PS in response to the pressure in the third direction PS may occur more easily, and the capacitance of the capacitor CS may also be changed more easily, resulting in an increase of the sensitivity of the pressure sensor PS.

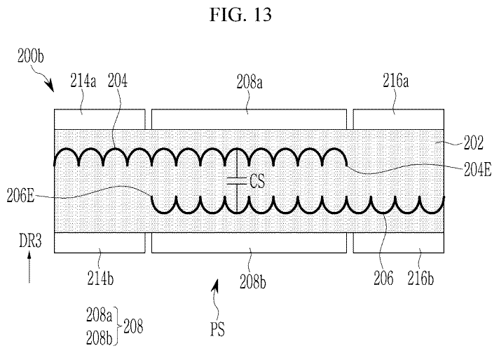

FIG. 13 is a cross-sectional view of a sensor device according to an embodiment.

Referring to FIG. 13, a sensor device 200b according to an embodiment is similar to the sensor device 200 or the sensor device 200a described above, but may further include deformation sensors 214a, 214b, 216a, 216b (or also referred to as a strain sensor). The deformation sensors 214a, 214b, 216a, 216b are positioned on the upper and/or the lower surface of the substrate 202 and may be positioned apart from the capacitor CS of the pressure sensor PS in plan view. That is, the deformation sensors 214a, 214b, 216a, 216b may not overlap with the pressure sensor PS in the third direction DR3 and may be spaced apart from the deformation controller 208 in the plane. Each deformation sensor 214a, 214b, 216a, 216b may overlap one of the first wire 204 and the second wire 206 in the third direction DR3. The deformation sensors 214a, 214b, 216a, 216b may be in direct contact with the upper and/or the lower surface of the substrate 202, and a component of a treatment solution for adhesion (e.g., APTES, etc.) may remain at the interface.

The deformation sensors 214a, 214b, 216a, 216b may detect the deformation (strain) of the substrate 202 in the planar direction of the substrate 202 by not responding to the pressure in the third direction DR3 but reacting to deformation such as the stretch or the contraction in the planar direction of the substrate 202. The signal processor 210 may use the sensing signals from the deformation sensors 214a, 214b, 216a, 216b to separate the influence of deformation, such as the stretch and the contraction in the planar direction of the substrate 202, from the sensing signal of the pressure sensor PS, thereby generating sensing data that corresponds only to the pressure in the third direction DR3. Accordingly, the sensitivity and accuracy of the pressure sensor PS for the purpose of detecting pressure in the third direction DR3 may be further improved.

The deformation sensors 214a, 214b, 216a, and 216b may include at least one first deformation sensor 214a or 216a, which is positioned on the upper surface of the substrate 202 embedding the first wire 204 and adjacent to the first deformation controller 208a, and at least one second deformation sensor 214b or 216b, which is positioned on the lower surface of the substrate 202 embedding the second wire 206 and adjacent to the second deformation controller 208b. According to an embodiment, at least one of a plurality of deformation sensors 214a, 214b, 216a, and 216b may be omitted.

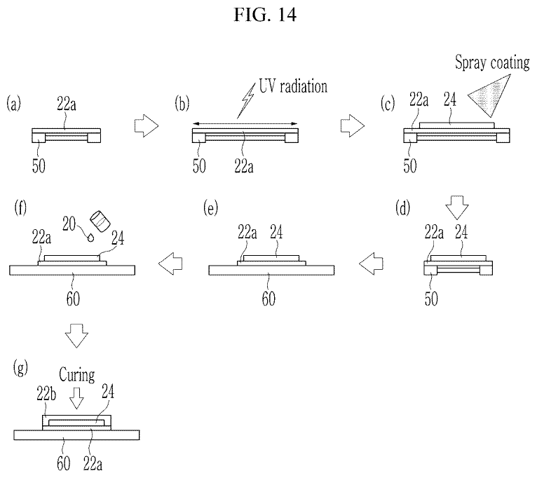

A method of manufacturing a sensor device according to an embodiment will be described with reference to FIGS. 14 to 19 together with the previous drawings.

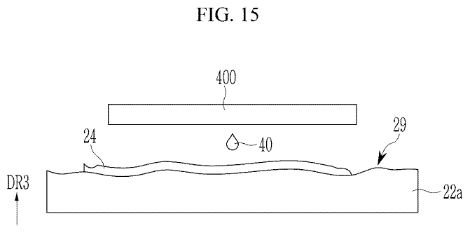

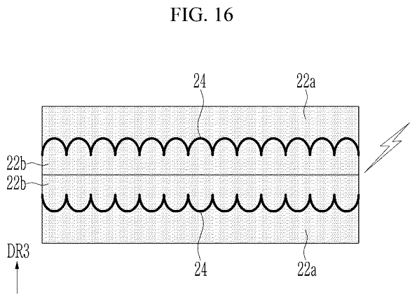

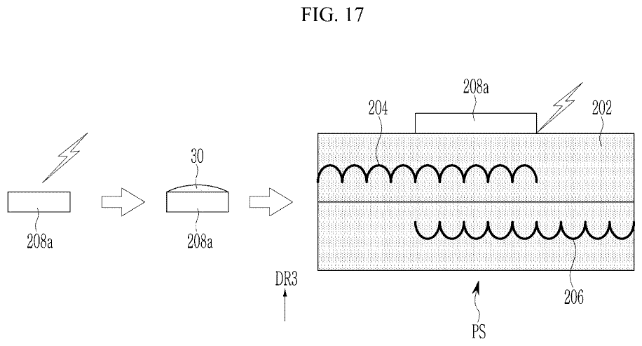

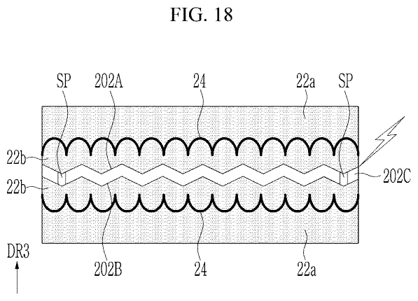

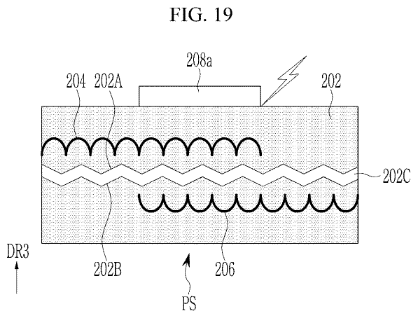

FIG. 14 is a drawing sequentially illustrating sequential processes of a method of manufacturing a sensor device according to an embodiment. FIG. 15 is a cross-sectional view illustrating a process step in a method of manufacturing a sensor device according to an embodiment. FIG. 16 is a cross-sectional view illustrating a process step in a method of manufacturing a sensor device according to an embodiment. FIG. 17 is a cross-sectional view illustrating a process step after the process step shown in FIG. 16 in a method of manufacturing a sensor device according to an embodiment. FIG. 18 is a cross-sectional view illustrating a process step in a method of manufacturing a sensor device according to an embodiment. FIG. 19 is a cross-sectional view illustrating a process step after the process step shown in FIG. 18 in a method of manufacturing a sensor device according to an embodiment.

Referring to FIG. 14(a), the first substrate part 22a including a stretchable material such as PDMS is fixed to the jig 50 that is operable in the planar direction.

Subsequently, as shown in FIG. 14(b), the first substrate part 22a fixed to the jig extends (e.g., 37%) to the horizontal direction (e.g., 37%) and UV treatment is performed on the first substrate portion 22a for a predetermined time (e.g., 20 minutes)

Next, as shown in FIG. 14(c), a conductive material for wire, such as silver nanowire AgNW, is spray-coated on the first substrate part 22a to form a wiring layer 24, and the top of the wiring layer 24 is cleaned. A method of forming the wiring layer 24 is not limited thereto, and the wiring layer 24 may be formed by a solution process or by attaching an already formed electrode onto the first substrate part 22a.

Next, as shown in FIG. 14(d), the jig 50 is returned to its original state to make the wiring layer 24 in a crooked/curved shape or in a corrugated structure.

Next, as shown in FIG. 14(e), the first substrate part 22a is separated from the jig 50, and the first substrate part 22a is placed on the working substrate 60 such as a glass substrate.

Next, as shown in FIG. 14(f), a substrate material 20 containing a stretchable material such as PDMS is spin-coated on the wiring layer 24 on the first substrate part 22a.

Then, as shown in FIG. 14(g), the second substrate part 22b formed of the coated substrate material 20 is thermally cured for a certain period of time (e.g., 1 hour) in a certain temperature range (e.g., about 120 degrees Celsius).

As a result, a wiring layer 24 that is positioned between the first substrate part 22a and the second substrate part 22b is embedded in the substrate and may have a corrugated structure or a crooked/curved shape. When the wiring layer 24 is formed as a patterned electrode on the plane of the first substrate part 22a, the wiring layer 24 may include the wires 204 and 206 as described above.

Referring to FIG. 15, unlike using the jig 50 in the manufacturing method shown in FIG. 14, the upper surface of the first substrate part 22a may be surface-treated or dry-etched to have a curved or an uneven surface of the first substrate part 22a. Subsequently, as described in FIG. 14(c), a wiring layer 24 having a crooked/curved surface or a corrugated structure may be formed by printing a conductive material 40 for wire, such as silver nanowires AgNW, on the curved surface 29 of the first substrate part 22a. In this case, the wiring layer 24 may be screen-printed on the first substrate part 22a using the printing device 400. A subsequent process may be the same as the processes illustrated in FIG. 14(e), FIG. 14(f), and FIG. 14(g) described above.

Referring to FIG. 16, following the processes shown in FIG. 14 or 15, two substrates, each of which includes a first substrate part 22a, a second substrate part 22b and a wiring layer 24 embedded between the first substrate part 22a and the second substrate part 22b, are manufactured. These two substrates are aligned and coupled so that each of the second substrate parts 22b of the substrates faces each other. The bonding process of the second substrate part 22b of the two substrates may use air plasma (indicated as a lightning shape). The two combined substrates may form the sensor device 200 including the pressure sensor PS described above.

Next, as shown in FIG. 17, UV treatment is performed on the first deformation controller 208a for a certain period of time (e.g., 20 minutes), and surface treatment is performed on one surface of the first deformation controller 208a with a solution 30 such as 3-Aminopropyltriethoxysilane (APTES). Subsequently, the surface of the surface-treated first deformation controller 208a may be coupled to the upper surface of the substrate 202 in which the pressure sensor PS is formed. The coupling process between the first deformation controller 208a and the substrate 202 may use air plasma. Likewise, the second deformation controller 208b may also be coupled to the bottom surface of the substrate 202.

Referring to FIG. 18, following the processes shown in FIG. 14 or 15, two substrates, each of which includes a first substrate part 22a, a second substrate part 22b, and a wiring layer 24 embedded between the first substrate part 22a and the second substrate part 22b, are manufactured. A surface of the second substrate part 22b of each substrate is formed as a curved surface to form a curved first gap surface 202A and a curved second gap surface 202B. The method of forming the curved surface may include various methods such as patterning or surface treatment of the surface of the second substrate part 22b, or forming the curved surface with a mold before the thermal curing process described in FIG. 14(g), and then performing thermal curing.

Subsequently, a spacer SP is placed on a part of the second substrate part 22b of one of the two substrates, and the two substrates are aligned and coupled so that each of the second substrate parts 22b of the two substrates faces each other. The spacing between the two second substrate parts 22b may be maintained by the spacer SP, and the spacing portion may form the gap 202C described above.

The coupling process of the second substrate part 22b of the two substrates may use air plasma (indicated in a lightning shape). The two combined substrates may form a sensor device (200a) including a pressure sensor (PS) as described above.

Next, referring to FIG. 19, as described above in FIG. 17, after UV treatment is performed on the first deformation controller 208a for a certain period of time (e.g., 20 minutes), surface treatment is performed on one surface of the first deformation controller 208a using a solution such as 3-Aminopropyltriethoxysilane (APTES). Next, the surface of the surface-treated first deformation controller 208a may be bonded to the upper surface of the substrate 202 in which the pressure sensor PS of the sensor device (200a) is formed. The coupling process between the first deformation controller 208a and the substrate 202 may use air plasma. Likewise, the second deformation controller 208b may also be coupled to the bottom surface of the substrate 202.

The display device according to the above embodiments can be applied to various electronic devices. An electronic device according to an embodiment comprises the aforementioned display device and may further comprise a module or a device with additional functions other than the display device.

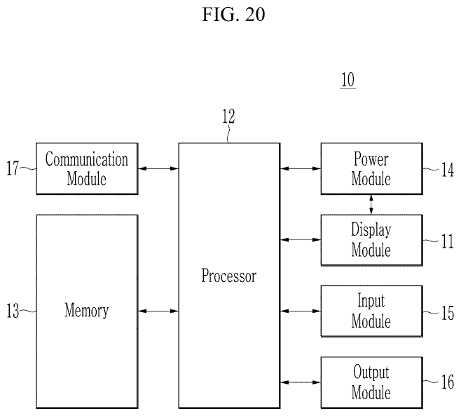

FIG. 20 is a block diagram of an electronic device according to an embodiment. Referring to FIG. 20, an electronic device 10 according to an embodiment may comprise a display module 11, a processor 12, a memory 13, and a power module 14. The electronic device 10 may further comprise an input module 15, a non-visual output module 16, and/or a communication module 17. The display module 11 may comprise a display device according to an embodiment as described above.

The electronic device 10 may output various information in the form of images via the display module 11. When the processor 12 executes an application stored in the memory 13, an image information provided from the application may be provided to a user via the display module 11. The power module 14 may comprise a power supply module such as a power adapter or a battery device, and a power conversion module that converts the power supplied by the power supply module to generate the power necessary for operation of the electronic device 10. The input module 15 may provide an input information to the processor 12 and/or the display module 11. The non-visual output module 16 may receive information other than the image information, such as sound, haptic, or light information provided from the processor 12, and provide it to the user. The communication module 17 is responsible for transmitting and receiving information between the electronic device 10 and an external device, and may comprise a receiver and a transmitter.

At least one of the aforementioned components of the electronic device 11 may be included within the display device according to the above-described embodiments. In addition, some of the individual modules that are functionally included in one module may be included within the display device, while others may be provided separately from the display device. For example, a display device according to an embodiment may include the display module 11, while the processor 12, the memory 13, and the power module 14 may be provided in a form of other devices within the electronic device 11, not within the display device.

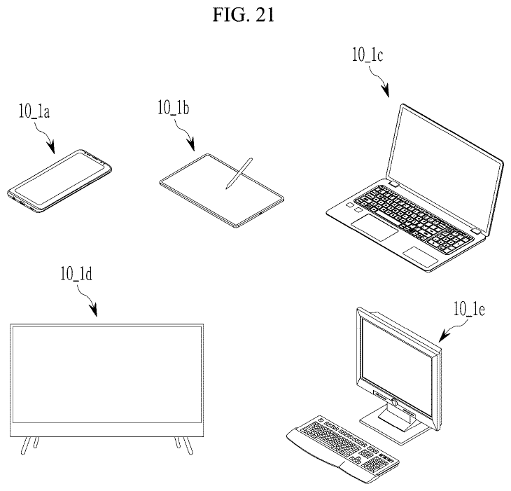

FIG. 21 to FIG. 23 are schematic diagrams of electronic devices according to various embodiments. FIG. 21 to FIG. 23 illustrate examples of various electronic devices to which a display device according to an embodiment is applied.

FIG. 21 illustrates examples of electronic devices, including a smartphone 10_1a, a tablet PC 10_1b, a laptop 10_1c, a TV 10_1d, and a desktop monitor 10_1e.

A smartphone 10_1a may comprise an input module such as a touch sensor and a communication module in addition to the display module 11. The smartphone 10_1a may process information received through the communication module or other input modules and display the information through the display module of the display device.

Each of the tablet PC 10_1b, the laptop 10_1c, the TV 10_1d, and the desktop monitor 10_1e may comprise a display module and an input module similar to the smartphone 10_1a, and may additionally comprise a communication module depending on embodiments.

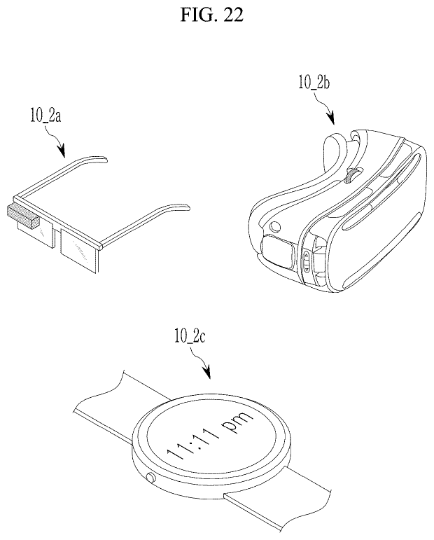

FIG. 22 illustrates an example where an electronic device including a display module is applied to a wearable electronic device. The wearable electronic device may be smart glasses 10_2a, a head-mounted display 10_2b, a smart watch 10_2c, and so on.

The smart glasses 10_2a and the head-mounted display 10_2b may comprise a display module that projects display images and a reflector that reflects the projected display images to provide it to a user's eyes, through which, a screen of virtual reality or augmented reality may be provided to the user.

The smart watch 10_2c may comprise a biometric sensor as an input device, and may provide biometric information recognized through the biometric sensor to a user via a display module.

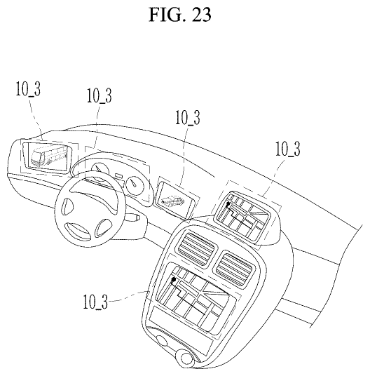

FIG. 23 illustrates an example of an electronic device including a display module applied to a vehicle. For example, an electronic device 10_3 may be applied to an instrument panel, or a center fascia, etc. of a car, or it may be applied to a CID (Center Information Display) placed on a dashboard of a car, or it may be applied to a room mirror display replacing a side mirror.

Although not illustrated, an electronic device to which a display device according to embodiments is applied may include not only devices primarily focused on screen display such as a billboard, an electronic signboard, and a gaming machine, but also various home appliances that display information through a display module, such as a refrigerator, a washing machine, a dryer, an air conditioner, and a robot vacuum cleaner. Furthermore, when the display module has a light-transmitting function, it can be applied to an electronic device such as a smart window or a transparent display device that show both the background and a displayed image. The types of electronic devices according to the embodiments are not limited to the examples given above, and application to various other electronic devices not mentioned may also be possible.

Although the embodiments of the present disclosure have been described in detail above, it is understood that the scope of the present disclosure is not limited to the disclosed embodiments. On the contrary, it is intended to cover various modifications and equivalent arrangements included within the spirit and scope of the appended claims.

What is claimed is:

1. A sensor device comprising:
a substrate having stretchability,
a first wire and a second wire embedded in the substrate and spaced apart from each other in a first direction, and
a deformation controller positioned on a first surface of the substrate,
wherein the first wire overlaps the second wire in the first direction to form a capacitor,
the deformation controller overlaps the capacitor in the first direction,
a Young's modulus of the deformation controller is greater than a Young's modulus of the substrate, and
the substrate has a gap between the first wire and the second wire.

2. The sensor device of claim 1,
wherein the gap is filled with air.

3. The sensor device of claim 2,
wherein the substrate comprises a first portion embedding the first wire and a second portion embedding the second wire,
the first portion comprises a first gap surface defining the gap, and
the second portion comprises a second gap surface that defines the gap and faces the first gap surface.

4. The sensor device of claim 3,
wherein each of the first gap surface and the second gap surface includes a curved surface.

5. The sensor device of claim 4,
wherein each of the first gap surface and the second gap surface is parallel to each other.

6. The sensor device of claim 1,
wherein each of the first wire and the second wire includes a corrugated structure.

7. The sensor device of claim 1,
wherein each of the first wire and the second wire includes poly(3,4-ethylenedioxy-thiophene)-poly(styrene sulfonate) (PEDOT:PSS), and a silver nanowire (AgNW).

8. The sensor device of claim 1,
wherein the deformation controller overlaps one end of the first wire or is aligned with the one end in the first direction.

9. The sensor device of claim 1,
wherein the deformation controller comprises plastic.

10. The sensor device of claim 1,
further comprising a deformation sensor positioned on a first surface of the substrate or a second surface of the substrate facing the first surface.

11. The sensor device of claim 10,
wherein the deformation sensor is spaced apart from the capacitor in the first direction.

12. The sensor device of claim 11,
wherein the deformation sensor is spaced apart from the deformation controller in a plane.

13. The sensor device of claim 12,
further comprising a signal processor using a sensing signal of the deformation sensor, separating the influence of deformation in the planar direction of the substrate from a sensing signal of the pressure sensor, and generating a sensing data corresponding to a pressure in the first direction.

14. A sensor device comprising:
a substrate having stretchability,
a first wire and a second wire embedded in the substrate and spaced apart from each other in a first direction,
a deformation controller positioned on a first surface of the substrate, and
a deformation sensor positioned on the first surface of the substrate or on a second surface of the substrate facing the first surface,
wherein the first wire overlaps the second wire in the first direction to form a capacitor,
the deformation controller overlaps the capacitor in the first direction, and
the deformation sensor is spaced apart from the capacitor in the first direction.

15. The sensor device of claim 14,
wherein the deformation sensor is spaced apart from the deformation controller in a plane.

16. The sensor device of claim 14,
further comprising a signal processor using a sensing signal of the deformation sensor, separating the influence of deformation in the planar direction of the substrate from a sensing signal of the pressure sensor, and generating a sensing data corresponding to a pressure in the first direction.

17. The sensor device of claim 14,
wherein each of the first wire and the second wire includes a corrugated structure.

18. The sensor device of claim 14,
wherein the deformation controller overlaps one end of the first wire or is aligned with the one end in the first direction.

19. An electronic device comprising:
a display panel, and
a sensor device overlapping the display panel,
wherein the sensor device comprising:
a substrate having stretchability,
a first wire and a second wire embedded in the substrate and spaced apart from each other in a first direction, and
a deformation controller positioned on a first surface of the substrate,
wherein the first wire overlaps the second wire in the first direction to form a capacitor,
the deformation controller overlaps the capacitor in the first direction,
a Young's modulus of the deformation controller is greater than a Young's modulus of the substrate, and
each of the first wire and the second wire includes a corrugated structure.

20. The electronic device of claim 19,
further comprising a deformation sensor positioned on a first surface of the substrate or on a second surface of the substrate facing the first surface.
